(19) United States
(12) Patent Application Publication
(10) Pub. No.: US 2021/0127694 A1
(43) Pub. Date: May 6, 2021

(54) Pasteurization System For Liquid Food Product

(71) Applicant: Lingyu DONG, Temple City, CA (US)

(72) Inventor: Lingyu DONG, Temple City, CA (US)

(21) Appl. No.: 16/669,485

(22) Filed: Oct. 30, 2019

(51) Int. Cl. A23C 3/03; A23C 3/04

(52) U.S. Cl. CPC A23C 3/031; A23C 3/045

(57) ABSTRACT

A pasteurization system is configured for incorporating a food treatment system which includes a mix hopper, a freezing cylinder, and a cooling condenser. The pasteurization system includes a pasteurizing pipeline and a cooling module. The pasteurizing pipeline includes a forwarding passage guiding a heat exchanging medium from the compressor to the mix hopper and the freezing cylinder, and a returning passage guiding the heat exchanging medium from the mix hopper and the freezing cylinder back to the compressor through the cooling condenser. The cooling module is operatively coupled at the returning passage for not only reducing the temperature and pressure of the heat exchanging medium at the returning passage but also releasing an excessive energy of the heat exchanging medium before returning back to the compressor.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a liquid product preparation system, and more particularly to a pasteurization system for effectively deactivating unwanted substances in the liquid product in a high-pressure-high temperature closed system.

### Description of Arts

Pasteurization is a process for deactivating unwanted substances in the liquid product, such as milk or fruit juice, before the liquid product is packed. A conventional pasteurization system comprises a delivering pipeline for delivering the liquid product, and a heat exchanging system for heat exchanging with the liquid product along the delivering pipeline. The heat exchanging system comprises a heat exchanging pipeline for delivering a heat exchanging medium and a heat pump compressor for heating up the heat exchanging medium along the heat exchanging pipeline. Therefore, the liquid product is heated up via the heat exchange of the heating exchanging medium.

One type of heat exchanging system is a closed system that the heat exchanging medium is returned back to the heat pump compressor after the liquid product is heated by the heat exchanging medium. In other words, after the pasteurization of the liquid product, the heat exchanging medium is remained in the high-temperature-high-pressure manner. It is burden for the heat pump compressor to handle the heat exchanging medium in such a high-temperature-high-pressure manner. Therefore, the heat exchanging system further comprises a cooling module, such as one or more expansion valves, coupled at the heat exchanging pipe to cool down the heating exchanging medium before returning back to the heat pump compressor. In other words, the expansion valves are configured to expand the heat exchanging medium to reduce the temperature and pressure of the heat exchanging medium. However, the major drawback of the cooling module is that the expansion valves cannot release the high temperature and high pressure energy from the heat exchanging system. In other words, even though the cooling module can cool down the heat exchanging medium but cannot release the energy from the heat exchanging medium, such that the unreleased energy will affect the stability of the heat exchanging system. In fact, the cooling module will complicate the configuration of the heat exchanging system and is unstable during the operation. Therefore, most conventional heat exchanging systems are a semi-closed system to handle the heat exchanging medium in such a high-temperature-high-pressure manner. However, the semi-closed system has the drawbacks of bigger overall size, lacking of expansion ability, higher energy consumption, and higher operation costs.

### SUMMARY OF THE PRESENT INVENTION

The invention is advantageous in that it provides a pasteurization system for effectively deactivating unwanted substances in the liquid product in a high-pressure-high temperature closed system.

Another advantage of the invention is to provide a pasteurization system, which is configured to incorporate with a food treatment system to form a closed system for effectively deactivating unwanted substances thereof.

Another advantage of the invention is to provide a pasteurization system, which comprises a plurality of capillary units for reducing the temperature and pressure of the heat exchanging medium to flow back to the compressor.

Another advantage of the invention is to provide a pasteurization system, wherein the capillary units are individually operated for fine-adjusting the temperature and pressure of the heat exchanging medium to flow back to the compressor.

Another advantage of the invention is to provide a pasteurization system, which is configured to guide the heat exchanging medium to pass through said cooling condenser twice, so as to effectively reduce the temperature and pressure of the heat exchanging medium before flowing back to the compressor.

Another advantage of the invention is to provide a pasteurization system, which does not require altering the original structural design of the food treatment system, so as to minimize the manufacturing cost of the food treatment system that incorporates the pasteurization system.

Another advantage of the invention is to provide a pasteurization system, wherein no expensive or complicated structure is required to employ the present invention in order to achieve the above mentioned objectives. Therefore, the present invention successfully provides an economic and efficient solution for effectively deactivating unwanted substances in the liquid product, and for enhancing the operation of the food treatment system in a stable and safe manner.

Additional advantages and features of the invention will become apparent from the description which follows, and may be realized by means of the instrumentalities and combinations particular point out in the appended claims.

According to the present invention, the foregoing and other objects and advantages are attained by a food treatment system for a liquid product, comprising a product delivering module and a pasteurization system

The product delivering module, which comprises a compressor, is configured for delivering the liquid product. The pasteurization system comprises a pasteurizing pipeline and a cooling module.

The pasteurizing pipeline comprises a forwarding passage guiding a heat exchanging medium toward the product delivering module and a returning passage guiding the heat exchanging medium from the product delivering module, wherein the compressor is operatively coupled at the forwarding passage for increasing temperature and pressure of the heat exchanging medium therealong to heat exchange with the liquid product at the product delivering module.

The cooling module is operatively coupled at the returning passage for not only reducing the temperature and pressure of the heat exchanging medium after being heat-exchanged with the liquid product but also releasing an excessive energy of the heat exchanging medium before returning back to the compressor.

In accordance with another aspect of the invention, the present invention comprises a pasteurization system for a food treatment system which comprises a mix hopper, a freezing cylinder, and a cooling condenser, wherein the pasteurization system comprises the pasteurizing pipeline and the cooling module.

In accordance with another aspect of the invention, the present invention comprises a pasteurization method for a food treatment system which comprises a mix hopper, a freezing cylinder, and a cooling condenser, comprising the following steps.

(A) Configure a forwarding passage to guide a heat exchanging medium from the compressor to the mix hopper and the freezing cylinder.

(B) Configure a returning passage to guide the heat exchanging medium from the mix hopper and the freezing cylinder back to the compressor through the cooling condenser.

(C) Operatively provide a cooling module operatively at the returning passage for not only reducing a temperature and pressure of the heat exchanging medium at the returning passage but also releasing an excessive energy of the heat exchanging medium before returning back to the compressor.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a diagram of a food treatment system incorporated with a simplified pasteurization system according to a preferred embodiment of the present invention.

FIG. 2 is a diagram of a food treatment system incorporated with a modified pasteurization system according to the preferred embodiment of the present invention.

FIG. 3 is a block diagram illustrating the pasteurization method according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

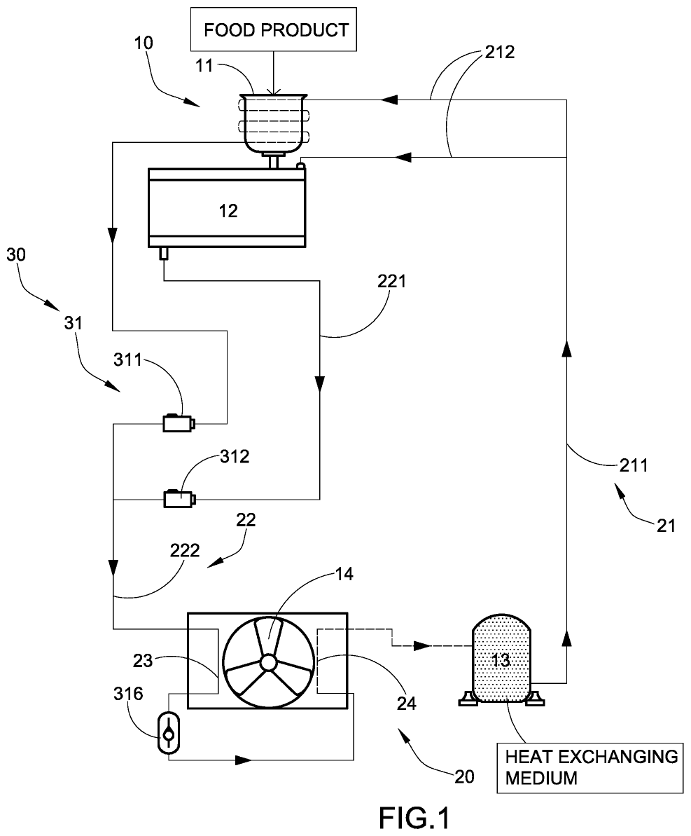

Referring to FIG. 1 of the drawings, a food treatment system 10 incorporated with a simplified pasteurization system according to a preferred embodiment of the present invention is illustrated, wherein the food treatment system 10 is configured for treating a liquid product, such as milk product and the like. The pasteurization system is configured for effectively deactivating unwanted substances in the liquid product in a high-pressure-high temperature closed system.

As shown in FIG. 1 of the drawings, the food treatment system 10 comprises a mix hopper 11 for receiving and mixing the liquid product, and a freezing cylinder 12 operatively connected to the mix hopper 11 for freezing the liquid product from the mix hopper 11. The food treatment system 10 further comprises a compressor 13 and a cooling condenser 14. In one embodiment, the cooling condenser 14 is embodied as a cooling fan.

The pasteurization system comprises a pasteurizing pipeline 20 for guiding a heat exchanging medium through the food treatment system 10 and a cooling module 30 for cooling the heat exchanging medium. In one example, the heat exchanging medium can be a refrigerant, wherein the heat exchanging medium is arranged to heat-exchange with the liquid product for heating up the liquid product so as to deactivate unwanted substances in the liquid product, such that the heat exchanging medium is cooled down by the cooling module 30 after the heat exchanging process.

As shown in FIG. 1, the pasteurizing pipeline 20 comprises a forwarding passage 21 guiding the heat exchanging medium from the compressor 13 and a returning passage 22 guiding the heat exchanging medium back to the compressor 13. Accordingly, the compressor 13 is operatively coupled at the forwarding passage 21 for increasing temperature and pressure of the heat exchanging medium therealong to heat exchange with the liquid product at the product delivering module 10. The cooling condenser 14 is operatively coupled at the returning passage 22 for cooling the heat exchanging medium before flowing back to the compressor 13.

Particularly, the forwarding passage 21 is defined to guide the heat exchanging medium from the compressor 13 to the mix hopper 11 and the freezing cylinder 12. The returning passage 22 is defined to guide the heat exchanging medium from the mix hopper 11 and the freezing cylinder 12 back to the compressor 13 through the cooling condenser 14.

As shown in FIG. 1, the forwarding passage 21 has one first forwarding line 211 connected to the compressor 13 and two second forwarding lines 212 connected to the mix hopper 11 and the freezing cylinder 12 respectively. In other words, the first forwarding line 211 is split to form the two second forwarding lines 212, such that the heat exchanging medium is guided to exit from the compressor 13 along the first forwarding line 211 and is split to enter to the mix hopper 11 and the freezing cylinder 12 along the second forwarding lines 212 respectively.

The returning passage 22 has two first returning lines 221 connected to the mix hopper 11 and the freezing cylinder 12 respectively and one second returning line 222 connected to the compressor 13. The first returning lines 221 are combined and connected to form the second returning line 222, such that the heat exchanging medium is guided to exit from the mix hopper 11 and the freezing cylinder 12 along the first returning lines 221 and is then combined to enter back to the compressor 13 through the cooling condenser 14.

It is worth mentioning that after the first returning lines 221 are combined and connected to form the second returning line 222, the second returning line 22 is configured to connect to the cooling condenser 14 before connecting to the compressor 13. As shown in FIG. 1, the returning passage 22 is configured to have a first condenser line section 23 and a second condenser line section 24 at the second returning line 222. The first condenser line section 23 is a section of the second returning line 222 and is extended from the combined first returning lines 221 to the cooling condenser 14, such that the heat exchanging medium is guided to flow to the cooling condenser 14 along the first condenser line section 23 for being cooled at the first time. The second condenser line section 24 is another section of the second returning line 222 and is extended from an outlet of the first condenser line section 23 for detouring the heat exchanging medium back to the cooling condenser 114, such that the heat exchanging medium is guided to flow back to the cooling condenser 14 along the second condenser line section 24 for being cooled at the second time. In other words, the heat exchanging medium is guide for passing to the cooling condenser 14 twice before returning back to the compressor 13.

According to the preferred embodiment, the cooling module 30 comprises a valve arrangement 31 operatively coupled at the pasteurizing pipeline 20 for selectively controlling a temperature and pressure of the heat exchanging medium therealong. Accordingly, the valve arrangement 31 comprises first and second valve units 311, 312 operatively coupled at the first returning lines 221 respectively. In one embodiment, the first and second valve units 311, 312 are solenoid valves. The valve arrangement 31 further comprises a first check valve 316 operatively connected between the first condenser line section 23 and the second condenser line section 24, such that the heat exchanging medium is guided to pass through the first check valve 316 after the heat exchanging medium passes through the cooling condenser 14 at the first condenser line section 23 and before the heat exchanging medium returns back to the cooling condenser 14 at the second condenser line section 24.

As shown in FIG. 1, the flow line of the heat exchanging medium at the pasteurizing pipeline 20 is illustrated as a solid line to show the high pressure of the heat exchanging medium, and the flow line of the heat exchanging medium at the pasteurizing pipeline 20 is illustrated as a dotted line to show the low pressure of the heat exchanging medium. In other words, the heat exchanging medium at the forwarding passage 21 is retained under high pressure. The heat exchanging medium passing through the mix hopper 13 is retained under low pressure. The heat exchanging medium passing from the mix hopper 11 and the freezing cylinder 14 is retained under high pressure. The heat exchanging medium passing from the freezing cylinder 14 to the compressor 13 is retained under low pressure.

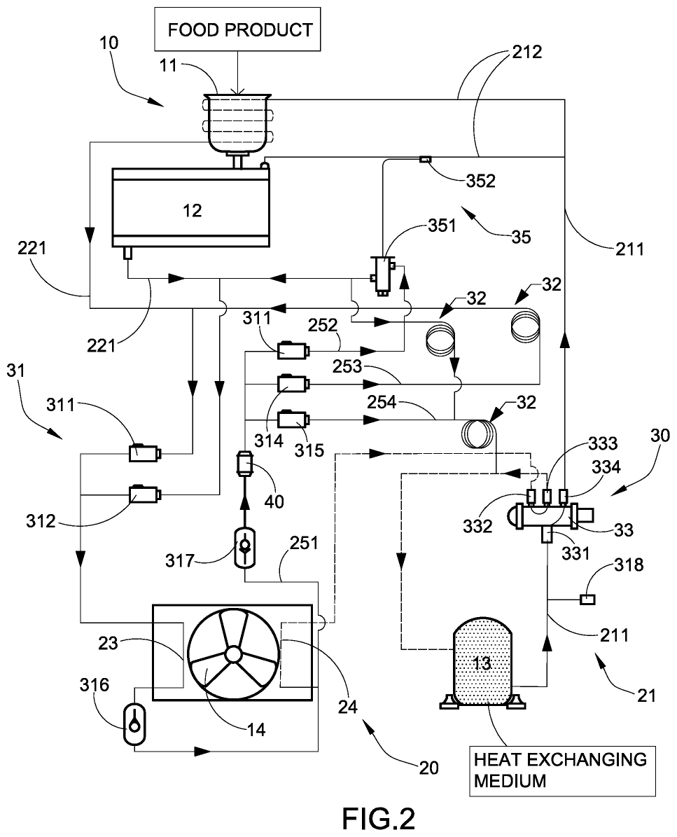

FIG. 2 illustrates the pasteurization system as a modification of the FIG. 1 to include all the structural and operational configuration in the FIG. 1.

As shown in FIG. 2, the cooling module 30 comprises a plurality of capillary units 32 operatively coupled at the returning passage 22 for selectively controlling the temperature and pressure of the heat exchanging medium before flowing back to the compressor 13. In one embodiment, the capillary units 32 are capillary tubes and capillary fins for reducing the heat exchanging medium from high pressure to low pressure. Each of the capillary unit 32 is operated and controlled individually, such that the pressure of the heat exchanging medium can be selectively adjusted at the returning passage 22 before returning back to the compressor 13. In other words, the capillary units 32 are configured for fine-adjusting the temperature and pressure of the heat exchanging medium before flowing back to the compressor 13.

In one embodiment, the capillary units 32 are connected parallel with each other at the returning passage 22 and are located between the cooling condenser 14 and the compressor 13. In other words, the returning passage 22 is split into a plurality of parallel lines between the cooling condenser 14 and the compressor 13, such that the capillary units 32 are operatively coupled at the parallel lines of the returning passage 14 respectively.

As shown in FIG. 2, there are three capillary units 32 provided at the returning passage 22. The pasteurizing pipeline 20 comprises a plurality of detouring lines, i.e. the parallel lines as mentioned above. Preferably, the detouring lines are split from the second condenser line section 24 as shown in FIG. 2. A main detouring line 251 is split from the second condenser line section 24 before the second condenser line section 24 is extended to the cooling condenser 14. A plurality of sub-detouring lines 252, 253, 254, such as first, second and third sub-detouring lines in this example, are split from the main detouring line 251.

Accordingly, the capillary units 32 are operatively coupled at the sub-detouring lines 252, 523, 254 respectively. The valve arrangement 31 further comprises third, fourth and fifth valve units 313, 314, 315 operatively coupled at the sub-detouring lines 252, 523, 254 respectively, wherein the third, fourth and fifth valve units 313, 314, 315 are located in front of the capillary units 32, such that when the heat exchanging medium passes along the sub-detouring lines 252, 523, 254, the heat exchanging medium will firstly pass through the third, fourth and fifth valve units 313, 314, 315 and then the capillary units 32. Preferably, the third, fourth and fifth valve units 313, 314, 315 are also solenoid valves.

Particularly, the first sub-detouring line 252 is extended from the main detouring line 251 to connect with the third sub-detouring line 254. The second sub-detouring line 253 is extended from the main detouring line 251 to connect with one of the first returning lines 221 which is connected between the mix hopper 11 and the cooling condenser 14. The third sub-detouring line 254 is extended from the main detouring line 251 and is then combined with the first sub-detouring line 252 to connect with the second condenser line section 24 to the compressor 13.

The valve arrangement 31 further comprises a second check valve 317 operatively coupled at the main detouring line 251. Accordingly, the second check valve 317 is located at the main detouring line 251 before the sub-detouring lines 252, 253, 254 are split from the main detouring line 251.

The pasteurization system comprises a filter dryer 40 operatively coupled at the main detouring line 251, the filter dryer 40 is located at the main detouring line 251 between the second check valve 317 and the sub-detouring lines 252, 253, 254, such that the heat exchanging medium is guided to firstly pass the second check valve 217 and then the filter dryer 40 along the main detouring line 251 before the heat exchanging medium is guided to split at the sub-detouring lines 252, 253, 254. The filter dryer 40 is configured to filter and dry the heat exchanging medium for temperature control thereof.

The valve arrangement 31 further comprises a four way valve 33 operatively coupled at the pasteurizing pipeline 20 for detouring the flow of the heat exchanging medium. As shown in FIG. 2, the four way valve 33 has two valve inlets 331, 332 configured for operatively connecting to the compressor 13 and the cooling condenser 14 respectively, and two valve outlets 333, 334 configured for operatively connecting to the compressor 13 and the forwarding passage 21.

Accordingly, the first valve inlet 331 is operatively coupled at the first forwarding line 211 to communicate with the compressor 13, such that the heat exchanging medium is guided to flow from the compressor 13 to the first valve inlet 331 of the four way valve 33 along the first forwarding line 211.

The second valve inlet 332 is operatively connected to the second condenser line section 24, such that the heat exchanging medium is guided to flow from the cooling condenser 14 to the second valve inlet 332 of the four way valve 33 along the second condenser line section 24.

The first valve outlet 333 is communicatively linked to the second valve inlet 332, such that the heat exchanging medium is guided to flow into the second valve inlet 332 and is detoured to the third valve outlet 333. The third valve outlet 333 is operatively coupled at the second condenser line section 24, such that the heat exchanging medium is guided to flow from the first valve outlet 333 of the four way valve 33 to the compressor 13 along the second condenser line section 24 at a position after the first sub-detouring line 252 is combined with the second condenser line section 24.

The second valve outlet 334 is communicatively linked to the first valve inlet 331, such that the heat exchanging medium is guided to flow into the first valve inlet 331 and is detoured to the second valve outlet 334. The second valve outlet 334 is operatively coupled at the first forwarding line 211 to communicate with the mix hopper 11 and the freezing cylinder 12, such that the heat exchanging medium is guided to flow from the second valve outlet 334 of the four way valve 33 along the first forwarding line 211 to the mix hopper 11 and the freezing cylinder 12 via the second forwarding lines 212 respectively.

The valve arrangement 31 further comprises a pressure switch 318 operatively coupled at the first forwarding line 211 between the compressor 13 and the four way valve 33 for controlling a flow amount of the heat exchanging medium from the compressor 13.

The valve arrangement 31 further comprises a thermal expansion valve 35 operatively coupled at the pasteurizing pipeline 20 at the returning passage 22 thereof, wherein the thermal expansion valve 35 comprises a valve body 351 and a valve bulb 352. The valve body 351 has an expansion valve inlet operatively connected to the first sub-detouring line 252 to guide the heat exchanging medium into the valve body 351, and an expansion valve outlet connected to the respective capillary unit 32 and one of the first returning lines 221 which is connected between the freezing cylinder 12 and the cooling condenser 14. In other words, when the heat exchanging medium enters into the expansion valve inlet of the valve body 351, the heat exchanging medium is split to flow back to the first sub-detouring line 252 toward the corresponding capillary unit 32 and to flow to the corresponding first returning line 221 for combing the heat exchanging medium out of the freezing cylinder 12. The valve bulb 352 is connected to the valve body 351 and is electrically tapped at one of the second forwarding lines 212 which is connected to the freezing cylinder 12.

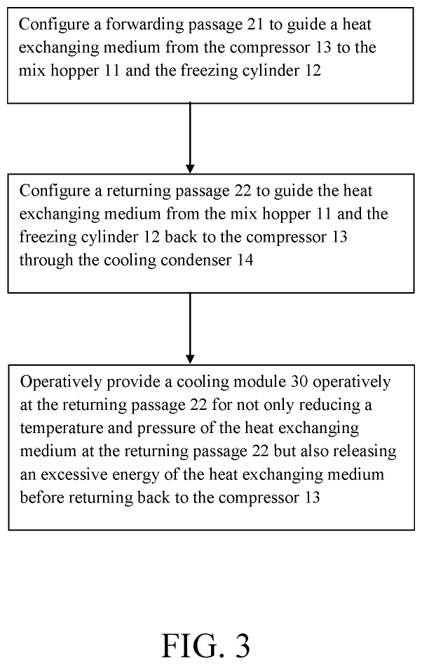

As shown in FIG. 3, the present invention further provides a pasteurization method for the food treatment system via the pasteurization system, wherein the pasteurization method comprises the following steps.

(1) Configure the forwarding passage 21 to guide the heat exchanging medium from the compressor 13 to the mix hopper 11 and the freezing cylinder 12.

(2) Configure the returning passage 22 to guide the heat exchanging medium from the mix hopper 11 and the freezing cylinder 12 back to the compressor 13 through the cooling condenser 14.

(3) Operatively provide the cooling module 30 operatively at the returning passage 22 for not only reducing the temperature and pressure of the heat exchanging medium at the returning passage 22 but also releasing an excessive energy of the heat exchanging medium before returning back to the compressor 13. Accordingly, the valve arrangement 31 and the capillary units 32 are incorporated with the cooling condenser 14 to reduce the temperature and pressure of the heat exchanging medium and to release the energy of the heat exchanging medium before returning back to the compressor 13.

The flow of the heat exchanging medium of the pasteurization system is illustrated in FIG. 2 that, by controlling the pressure switch 318, the heat exchanging medium is discharged from the compressor 13 in a high-pressure-high-temperature manner to the first valve inlet 331 of the four way valve 33 and is then exited at the second valve outlet 334 of the four way valve 33 along the first forwarding line 211. Then, the heat exchanging medium is split from the first forwarding line 211 to the second forwarding lines 212 and to flow to the mix hopper 11 and the freezing cylinder 12 respectively. After passing through the mix hopper 11 and the freezing cylinder 12, the heat exchanging medium is guided to flow along the first returning lines 221 through the first and second valve units 311, 312 respectively and is combined to flow along the second returning line 222 to the cooling condenser 14. It is worth mentioning that the heat exchanging medium is guided to pass through the cooling condenser 14 twice by the first condenser line section 23 and the second condenser line section 24. Then, a portion of the heat exchanging medium is remained at the second condenser line section 24 to flow toward the second valve inlet 332 of the four way valve 33, such that the heat exchanging medium is guided to flow from the first valve outlet 333 of the four way valve 33 back to the compressor 13 along the second condenser line section 24 in a low-pressure-low-temperature manner. Furthermore, a portion of the heat exchanging medium is split from the second condenser line section 24 to the main detouring line 251 to pass through the second check valve 317 and the filter dryer 40 in sequence. Then, the heat exchanging medium is split from the main detouring line 251 to the sub-detouring lines 252, 253, 254 to pass through the valve units 313, 314, 315 and the capillary units 32 in sequence. The heat exchanging medium is guided to flow along the first sub-detouring line 252 and is then guided to flow along the third sub-detouring line 254 through the thermal expansion valve 35. The heat exchanging medium is guided to flow along the second sub-detouring line 253 and is then guided to flow along one of the first returning lines 221 which is connected between the mix hopper 11 and the cooling condenser 14. The heat exchanging medium is guided to flow along the third sub-detouring line 254 and is then guided to flow along the second condenser line section 24 to the compressor 13. It is worth mentioning that, as shown in FIG. 2, the flow line of the heat exchanging medium at the pasteurizing pipeline 20 is illustrated as a solid line to show the high pressure of the heat exchanging medium, and the flow line of the heat exchanging medium at the pasteurizing pipeline 20 is illustrated as a dotted line to show the low pressure of the heat exchanging medium.

Particularly, in the step (3), the capillary units 32 are provided at the returning passage 22 between the cooling condenser 14 and the compressor 13 for controllably and adjustably reducing the pressure and temperature of the heat exchanging medium before returning back to the compressor 13. Through the capillary units 32, the energy of high-pressure-high-temperature of the heat exchanging medium can be effectively released by the operation of the cooling condenser 14 so as to substantially reduce the pressure and temperature of the heat exchanging medium. As a result, the low-pressure-high-temperature of the heat exchanging medium can be returned back to the compressor 13 to ensure the safety operation of the pasteurization system in a closed system.

In addition, the pasteurization system can be integrated with the food treatment system 10 to share the use of the cooling condenser 14. In other words, by adding the capillary units 32 to the cooling condenser 14, the capillary units 32 and the cooling condenser 14 can work together to substantially reduce the pressure and temperature of the heat exchanging medium before returning back to the compressor 13.

It is worth mentioning that the pressure and temperature of the heat exchanging medium can be selectively adjusted and fine-tuned via the capillary units 32 before returning back to the compressor 13. Accordingly, each of the capillary unit 32 is operated individually and independently, such that the pressure and temperature of the heat exchanging medium can be different after passing through the capillary units 32. For example, the pressure and temperature of the heat exchanging medium through the first capillary unit 32 can be higher than that through the second capillary units 32. Accordingly, no conventional system provides any fine-adjustment for the pressure and temperature of the heat exchanging medium.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A food treatment system for a liquid product, comprising:
a product delivering module configured for delivering the liquid product, wherein said product delivering module comprises a compressor; and
a pasteurization system, comprising:
a pasteurizing pipeline which comprises a forwarding passage guiding a heat exchanging medium from said compressor and a returning passage guiding the heat exchanging medium back to said product delivering module, wherein said compressor is operatively coupled at said forwarding passage for increasing temperature and pressure of the heat exchanging medium therealong to heat exchange with the liquid product at said product delivering module; and
a cooling module operatively coupled at said returning passage for not only reducing the temperature and pressure of the heat exchanging medium after being heat-exchanged with the liquid product but also releasing an excessive energy of the heat exchanging medium before returning back to said compressor.

2. The food treatment system, as recited in claim 1, wherein said product delivering module comprises a mix hopper for mixing the liquid product and a freezing cylinder connected to said mix hopper for freezing the liquid product from said mix hopper, wherein said forwarding passage has one first forwarding line connected to said compressor and two second forwarding lines connected to said mix hopper and said freezing cylinder respectively.

3. The food treatment system, as recited in claim 2, wherein said second forwarding lines are split from said first forwarding line.

4. The food treatment system, as recited in claim 2, wherein said returning passage has two first returning lines connected to said mix hopper and said freezing cylinder respectively and one second returning line connected to said compressor.

5. The food treatment system, as recited in claim 4, wherein said first returning lines are combined and connected to said second returning line.

6. The food treatment system, as recited in claim 1, wherein said product delivering module further comprises a cooling condenser operatively coupled at said returning passage for cooling the heat exchanging medium before flowing back to said compressor.

7. The food treatment system, as recited in claim 3, wherein said product delivering module further comprises a cooling condenser operatively coupled at said returning passage for cooling the heat exchanging medium before flowing back to said compressor.

8. The food treatment system, as recited in claim 7, wherein said returning passage is operatively coupled to said cooling condenser twice for guiding the heat exchanging medium to pass through said cooling condenser twice.

9. The food treatment system, as recited in claim 7, wherein said cooling module comprises two valve units operatively coupled at said first returning lines respectively, wherein said cooling condenser operatively coupled at said second returning line.

10. The food treatment system, as recited in claim 9, wherein said valve units are solenoid valve.

11. The food treatment system, as recited in claim 1, wherein said cooling module comprises a plurality of capillary units operatively coupled at said returning passage for fine-adjusting the temperature and pressure of the heat exchanging medium before flowing back to said compressor.

12. The food treatment system, as recited in claim 6, wherein said cooling module comprises a plurality of capillary units operatively coupled at said returning passage for fine-adjusting the temperature and pressure of the heat exchanging medium before flowing back to said compressor.

13. The food treatment system, as recited in claim 11, wherein said capillary units are connected parallel with each other at said returning passage.

14. The food treatment system, as recited in claim 12, wherein said capillary units are connected parallel with each other at said returning passage and are located between said cooling condenser and said compressor.

15. The food treatment system, as recited in claim 13, wherein said cooling module further comprises a plurality of valve units operatively coupled at said returning passage to align with said capillary units, such that said returning passage is configured to guide the heat exchanging medium to pass to said valve units before passing to said capillary units.

16. The food treatment system, as recited in claim 14, wherein said cooling module further comprises a plurality of valve units operatively coupled at said returning passage to align with said capillary units, such that said returning passage is configured to guide the heat exchanging medium to pass to said valve units before passing to said capillary units.

17. The food treatment system, as recited in claim 6, wherein said pasteurization system further comprises a four way valve operatively coupled at said pasteurizing pipeline, wherein said four way valve has two valve inlets operatively connected to said compressor and said cooling condenser respectively, and two valve outlets operatively connected to said compressor and said forwarding passage.

18. The food treatment system, as recited in claim 16, wherein said pasteurization system further comprises a four way valve operatively coupled at said pasteurizing pipeline, wherein said four way valve has two valve inlets operatively connected to said compressor and said cooling condenser respectively, and two valve outlets operatively connected to said compressor and said forwarding passage.

19. The food treatment system, as recited in claim 1, wherein said pasteurization system further comprises a thermal expansion valve operatively coupled at said returning passage.

20. The food treatment system, as recited in claim 18, wherein said pasteurization system further comprises a thermal expansion valve operatively coupled at said returning passage.

21. A pasteurization system for a food treatment system which comprises a mix hopper, a freezing cylinder, and a cooling condenser, comprising:
a pasteurizing pipeline which comprises a forwarding passage guiding a heat exchanging medium from the compressor to the mix hopper and the freezing cylinder, and a returning passage guiding the heat exchanging medium from the mix hopper and the freezing cylinder back to the compressor through the cooling condenser; and
a cooling module operatively coupled at said returning passage for not only reducing a temperature and pressure of the heat exchanging medium at said returning passage but also releasing an excessive energy of the heat exchanging medium before returning back to the compressor.

22. The pasteurization system, as recited in claim 21, wherein said cooling module comprises a plurality of capillary units operatively coupled at said returning passage between the cooling condenser and the compressor for fine-adjusting the temperature and pressure of the heat exchanging medium to flow back to the compressor.

23. The pasteurization system, as recited in claim 22, wherein said capillary units are connected parallel with each other at said returning passage and are configured for being located between the cooling condenser and the compressor.

24. The pasteurization system, as recited in claim 22, wherein said cooling module further comprises a plurality of valve units operatively coupled at said returning passage to align with said capillary units, such that said returning passage is configured to guide the heat exchanging medium to pass to said valve units before passing to said capillary units.

25. The pasteurization system, as recited in claim 24, wherein said valve units are solenoid valves.

26. The pasteurization system, as recited in claim 22, further comprising a four way valve operatively coupled at said pasteurizing pipeline, wherein said four way valve has two valve inlets configured for operatively connecting to the compressor and the cooling condenser respectively, and two valve outlets configured for operatively connecting to the compressor and said forwarding passage.

27. The pasteurization system, as recited in claim 21, wherein said pasteurization system further comprises a thermal expansion valve operatively coupled at said returning passage.

28. The pasteurization system, as recited in claim 21, wherein said pasteurization system further comprises a thermal expansion valve operatively coupled at said returning passage.

29. The pasteurization system, as recited in claim 21, wherein said returning passage comprises a first condenser line section configured for guiding the heat exchanging medium from the mix hopper and the freezing cylinder to the cooling condenser, and a second condenser line section extended from an outlet of said first condenser line section for detouring the heat exchanging medium back to the cooling condenser so as to guide the heat exchanging medium passing to the cooling condenser twice.

30. The pasteurization system, as recited in claim 21, wherein said returning passage comprises a check valve operatively coupled at between said first and second condenser line sections.

31. A pasteurization method for a food treatment system which comprises a mix hopper, a freezing cylinder, and a cooling condenser, comprising the steps of:
(a) configuring a forwarding passage to guide a heat exchanging medium from the compressor to the mix hopper and the freezing cylinder;
(b) configuring a returning passage to guide the heat exchanging medium from the mix hopper and the freezing cylinder back to the compressor through the cooling condenser; and
(c) operatively providing a cooling module operatively at said returning passage for not only reducing a temperature and pressure of the heat exchanging medium at said returning passage but also releasing an excessive energy of the heat exchanging medium before returning back to the compressor.

32. The pasteurization method, as recited in claim 31, wherein the step (c) comprises a step of operatively coupling a plurality of capillary units at said returning passage between the cooling condenser and the compressor for fine-adjusting the temperature and pressure of the heat exchanging medium to flow back to the compressor.

33. The pasteurization method, as recited in claim 32, wherein said capillary units are connected parallel with each other at said returning passage and are configured for being located between the cooling condenser and the compressor.

34. The pasteurization method, as recited in claim 32, wherein the step (c) further comprises a step of operatively coupling a plurality of valve units at said returning passage to align with said capillary units, such that said returning passage is configured to guide the heat exchanging medium to pass to said valve units before passing to said capillary units.

35. The pasteurization method, as recited in claim 32, wherein the step (b) comprises the steps of:
(b.1) configuring a first condenser line section of said returning passage for guiding the heat exchanging medium from the mix hopper and the freezing cylinder to the cooling condenser; and
(b.2) extending a second condenser line section of said returning passage from an outlet of said first condenser line section for detouring the heat exchanging medium back to the cooling condenser so as to guide the heat exchanging medium passing to the cooling condenser twice.
